(19) United States
(12) Patent Application Publication
(10) Pub. No.: US 2023/0048176 A1
(43) Pub. Date: Feb. 16, 2023

(54) FLEXIBLE POLYURETHANE FOAM

(71) Applicant: Covestro Deutschland AG, Leverkusen (DE)

(72) Inventors: Jun Zhang, Shanghai (CN); Weicheng Wu, Shanghai (CN); Jiejie He, Shanghai (CN); Qingyun Wang, Shanghai (CN); Hui Yu, Shanghai (CN)

(21) Appl. No.: 17/795,085

(22) PCT Filed: Mar. 22, 2021
(86) PCT No.: PCT/EP2021/057171

§ 371 Date: Jul. 25, 2022

(30) Foreign Application Priority Data
Mar. 27, 2020 (CN) 202010234058.8
Jun. 2, 2020 (EP) 20177796.8

(51) Int. Cl. C08G 18/48; C08G 18/76; C08G 18/75; C08G 18/73; C08G 18/08; C08G 18/18; C08J 9/12

(52) U.S. Cl. CPC C08G 18/4825; C08G 18/7621; C08G 18/757; C08G 18/735; C08G 18/14; C08G 18/18; C08J 9/125; C08G 2101/00

(57) ABSTRACT

The invention relates to a method for producing flexible polyurethane foam, flexible polyurethane foam produced by the method, and its use in household articles and automobile articles.

### CROSS REFERENCE TO RELATED APPLICATIONS

This application is a U.S. national stage application, filed under 35 U.S.C. § 371, of International Application No. PCT/EP2021/057171, which was filed on Mar. 22, 2021, and which claims priority to European Patent Application No. 20177796.8, which was filed on Jun. 2, 2020, and to Chinese Patent Application No. 202010234058.8 which was filed on Mar. 27, 2020. The contents of each are hereby incorporated by reference into this specification.

### TECHNICAL FIELD

The invention relates to a method for producing flexible polyurethane foam, polyurethane foam produced by the method, and the use of the flexible polyurethane foam in household articles and automobile articles.

### BACKGROUND TECHNIQUE

Flexible polyurethane foam, for its capability of providing excellent comfort and physical properties, is widely used in the household and automobile fields such as the production of sofas, mattresses, pillows, clothing paddings, automobile interiors, car seats, etc.

In industrial production, flexible polyurethane foam/high resilience foam can be produced by using continuous slabstock foam foaming process, non-continuous slabstock foam process and molding process.

The conventional production of flexible polyurethane foams employs polyether polyols and toluene diisocyanate as the main raw materials, water as the main blowing agent, organic tertiary amines type or organometallic type catalysts, and silicone type surface stabilizer or the like as additives, to conduct a foaming and molding reaction. However, toluene diisocyanate tends to hydrolyze to generate toxic substance toluene diamine, such that some foam products produced thereby contain a certain amount of toluene diamine. Most applications of flexible polyurethane foam involve close contact with human body. Toluene diamine is not easily volatile due to its high boiling point, the migration of which during use will do harm to human body. Therefore, all of the relevant international industry standards have set limitations for toluene diamine. For example, European CertiPUR and American CertiPUR-US both clearly stipulate that the detectable limit of toluene diamine in flexible polyurethane foam shall be less than 5 ppm. It is always a technical developing direction in the polyurethane industry to reduce the residue and release of toxic or harmful substances in the polyurethane system, and to produce healthier and environmentally friendly polyurethane products.

At present, attempts have been made in the field in providing methods to reduce VOC (volatile organic compounds) or aldehydes. For example, CN104321360A discloses a method for producing low VOC emission, especially low formaldehyde emission flexible polyurethane foam by adding 0.5-8 parts hexamethylene diisocyanate trimer and polyurea polyols. DE69312877T2 discloses a method for producing flexible polyurethane foam by using 0.5 to 30 parts hexamethylene diisocyanate to obtain improved mechanical properties and processibility.

Nevertheless, it is eagerly desired in the markets for methods for producing flexible polyurethane foams with excellent physical properties and low VOC, especially low toluene diamine content, and for foam products, to meet the demand for producing healthier and safer polyurethane products.

### SUMMARY OF THE INVENTION

In an aspect of the present invention, it is provided a method for producing a flexible polyurethane foam, comprising the production of the flexible polyurethane foam with a polyurethane reaction system comprising the following components:
Component A comprising:
   A1) toluene diisocyanate in a content of 15-80 pbw, preferably 30-65 pbw, based on 100 pbw of the component B;
   A2) at least one aliphatic isocyanate in a content of 1-13 pbw, preferably 1-12 pbw, more preferably 1-8 pbw, particularly preferably 4-7 pbw, based on 100 pbw of the component B;
Component B, one or more polyether polyol(s), comprising:
   B1) a polyether polyol having an ethylene oxide unit content of 0-30 wt. %, preferably 5-20 wt. % based on the total weight of B1, an average functionality of 2-4, and a hydroxyl value of 80-180 mg KOH/g (test method: GB/T 12008.3-2009), in a content of 30-100 pbw, preferably 80-100 pbw, based on 100 pbw of the component B;
Component C, at least one blowing agent; and
Component D, at least one amine catalyst.

Preferably, A2) the at least one aliphatic isocyanate is selected from the group consisting of isophorone diisocyanate, pentamethylene diisocyanate or a combination thereof, preferably isophorone diisocyanate.

Preferably, the component B further comprises:
B2) a polyether polyol having an ethylene oxide unit content of 0 wt. % based on the total weight of B2, an average functionality of 2-4, and a hydroxyl value of 200-340 mg KOH/g (test method: GB/T 12008.3-2009), in a content of 0-50 pbw, based on 100 pbw of the component B.

Preferably, the polyurethane reaction system further comprises:
B3) a polyether polyol having an ethylene oxide unit content of 30-80 wt. % based on the total weight of B3, an average functionality of 2-4, and a hydroxyl value of 20-60 mg KOH/g (test method: GB/T 12008.3-2009), in a content of 0-70 pbw, based on 100 pbw of the component B.

Preferably, the component C blowing agent is water in a content of 0.5-5 pbw, preferably 0.8-3.5 pbw, based on 100 pbw of the component B.

Preferably, the reaction system further comprises component E, at least one surfactant, in a content of 0.01-2 pbw, preferably 0.5-1.6 pbw, based on 100 pbw of the component B.

Preferably, the reaction system further comprises component F, at least one chain extender, in a content of preferably 0.3-5 pbw, preferably 0.3-2 pbw, based on 100 pbw of the component B.

Preferably, the reaction system does not include polyurea polyol.

Preferably, the reaction system or component A does not include hexamethylene diisocyanate. Preferably, the component A consists of the A1) and A2).

In another aspect of the present invention, it is provided a flexible polyurethane foam produced by the inventive method for producing flexible polyurethane foam.

Preferably, the flexible polyurethane foam has a tear strength ≥220 N/m, preferably ≥260 N/m, and more preferably ≥300 N/m (test method referring to GB/T 10808-2006).

Preferably, the flexible polyurethane foam has a tensile strength >72 kPa, preferably >75 kPa, more preferably ≥78 kPa (test method referring to GB/T 6344-2008).

Preferably, the flexible polyurethane foam has a content of 2,4-toluene diamine ≤30 mg/kg, preferably ≤25 mg/kg, and more preferably≤20 mg/kg.

Preferably, the flexible polyurethane foam has a 40% indentation hardness ≥35 N, preferably ≥40 N (test method referring to GB/T 10807-2006).

Preferably, the flexible polyurethane foam has an air permeability ≥100 L/min, preferably ≥110 L/min, more preferably ≥120 L/min (test method: ASTM D3574-G-2005).

Unexpectedly, it was found that, a flexible polyurethane foam produced by the inventive method with the use of a reaction system comprising an aliphatic diisocyanate and components adapted thereto, including polyether polyols, catalysts, blowing agents, and so on, exhibits not only excellent physical properties (such as good tensile strength, tear strength, indentation hardness, etc.), very good air permeability, but also a satisfactory low odor, especially a low or even undetectable content of toluene diamine. This method is simple, economical, and effective. It not only enables the production of more comfortable and breathable foam, but also results in the successful solution of problem caused by VOC such as toluene diamine, bringing out benefits to human health and environmental protection.

In another aspect of the present invention, it is provided use of an aliphatic isocyanate in flexible polyurethane foam for reducing the content of volatile organic compounds (VOC). Preferably, the volatile organic compound is toluene diamine.

Preferably, the flexible polyurethane foam is produced by a polyurethane reaction system comprising the following components:
Component A comprising:
   A1) toluene diisocyanate in a content of 15-80 pbw, preferably 30-65 pbw, based on 100 pbw of the component B;
   A2) at least one aliphatic isocyanate in a content of 1-13 pbw, preferably 1-12 pbw, more preferably 1-8 pbw, particularly preferably 4-7 pbw, based on 100 pbw of the component B;
Component B, one or more polyether polyol(s), comprising:
   B1) a polyether polyol having an ethylene oxide unit content of 0-30 wt. %, preferably 5-20 wt. % based on the total weight of B1, an average functionality of 2-4, and a hydroxyl value of 80-180 mg KOH/g (test method: GB/T 12008.3-2009), in a content of 30-100 pbw, preferably 80-100 pbw, based on 100 pbw of the component B;
Component C, at least one blowing agent; and
Component D, at least one amine catalyst.

Preferably, the aliphatic isocyanate is selected from the group consisting of isophorone diisocyanate, pentamethylene diisocyanate, pentamethylene diisocyanate or a combination thereof, preferably isophorone diisocyanate.

Preferably, the flexible polyurethane foam has a content of 2,4-toluene diamine ≤30 mg/kg, preferably ≤25 mg/kg, and more preferably ≤20 mg/kg.

Preferably, the flexible polyurethane foam has a 40% indentation hardness ≥35 N, preferably ≥40 N (test method referring to GB/T 10807-2006).

Preferably, the flexible polyurethane foam has an air permeability ≥100 L/min, preferably ≥110 L/min, more preferably ≥120 L/min (test method: ASTM D3574-G-2005).

In a yet another aspect of the present invention, it is provided use of the flexible polyurethane foam of the present invention in household or automobile articles.

In a yet another aspect of the present invention, it is provided a polyurethane product comprising the flexible polyurethane foam of the present invention.

Preferably, the polyurethane product is selected from the group consisting of household articles and automobile interiors, preferably sofas, mattresses, pillows, clothing paddings, back cushions, seat cushions and car seats.

### DETAILED DESCRIPTION

The following terms used in the present invention are defined or explained as follows.

Pbw means the mass parts of each component in the polyurethane reaction system;

Functionality means the value determined according to the equation in the field:

functionality=hydroxyl value*molecular weight/56100;

wherein the molecular weight is measured by GPC high-performance liquid chromatography with a test method referring to GB/T 21863-2008.

The method for producing flexible polyurethane foam of the present invention comprises the production of the flexible polyurethane foam by a polyurethane reaction system comprising the following components:
Component A comprising:
   A1) toluene diisocyanate in a content of 15-80 pbw, preferably 30-65 pbw, based on 100 pbw of the component B;
   A2) at least one aliphatic isocyanate in a content of 1-13 pbw, preferably 1-12 pbw, more preferably 1-8 pbw, particularly preferably 4-7 pbw, based on 100 pbw of the component B;
Component B, one or more polyether polyol(s), comprising:
   B1) a polyether polyol having an ethylene oxide unit content of 0-30wt. %, preferably 5-20 wt. % based on the total weight of B1, an average functionality of 2-4, and a hydroxyl value of 80-180 mg KOH/g (test method: GB/T 12008.3-2009), in a content of 30-100 pbw, preferably 80-100 pbw, based on 100 pbw of the component B;
Component C, at least one blowing agent; and
Component D, at least one amine catalyst.

Preferably, A2) the at least one aliphatic isocyanate is selected from the group consisting of isophorone diisocyanate, pentamethylene diisocyanate or a combination thereof, preferably isophorone diisocyanate.

Preferably, the component B further comprises:
B2) a polyether polyol having an ethylene oxide unit content of 0 wt. % based on the total weight of B2, an average functionality of 2-4, and a hydroxyl value of 200-340 mg KOH/g (test method: GB/T 12008.3-2009), in a content of 0-50 pbw, based on 100 pbw of the component B.

Preferably, the polyurethane reaction system further comprises:
B3) a polyether polyol having an ethylene oxide unit content of 30-80wt. % based on the total weight of B3, an average functionality of 2-4, and a hydroxyl value of 20-60 mg KOH/g (test method: GB/T 12008.3-2009), in a content of 0-70 pbw based on 100 pbw of the component B.

Preferably, the component C blowing agent is water in a content of 0.5-5 pbw, preferably 0.8-3.5 pbw, based on 100 pbw of the component B.

Preferably, the reaction system further comprises component E, at least one surfactant, in a content of 0.01-2 pbw, preferably 0.5-1.6 pbw, based on 100 pbw of the component B.

Preferably, the reaction system further comprises component F, at least one chain extender, in a content of preferably 0.3-5 pbw, preferably 0.3-2 pbw, based on 100 pbw of the component B.

Preferably, the reaction system does not include polyurea polyol.

Preferably, the reaction system or component A does not include hexamethylene diisocyanate.

For the method of the present invention, methods known to those skilled in the art such as non- continuous, continuous, or molding foaming reaction can be used.

The flexible polyurethane foam of the present invention is produced by the method for producing a flexible polyurethane foam of the present invention.

Preferably, the foam has a tear strength ≥220 N/m, preferably ≥260 N/m, and more preferably ≥300 N/m (test method referring to GB/T 10808-2006).

Preferably, the foam has a tensile strength >72 kPa, preferably >75 kPa, more preferably ≥78 kPa (test method referring to GB/T 6344-2008).

Preferably, the foam has a content of 2,4-toluene diamine ≤30 mg/kg, preferably ≤25 mg/kg, and more preferably ≤20 mg/kg.

Preferably, the foam has a 40% indentation hardness ≥35N, preferably ≥40N (GB/T 10807-2006).

Through a number of experiments, it has been unexpectedly found that a flexible polyurethane foam produced by the inventive method with the use of a reaction system comprising an aliphatic diisocyanate and components adapted thereto, including polyether polyols, catalysts, blowing agents, and so on, exhibits not only good physical properties (such as good tensile strength, tear strength, indentation hardness, etc.), excellent air permeability, but also a satisfactory low odor, especially a low or even undetectable content of toluene diamine.

The invention also provides use of an aliphatic isocyanate in the flexible polyurethane foam for reducing the content of volatile organic compounds (VOC). Preferably, the volatile organic compound is toluene diamine.

Preferably, the aliphatic isocyanate is selected from the group consisting of isophorone diisocyanate, pentamethylene diisocyanate or a combination thereof, preferably isophorone diisocyanate.

The flexible polyurethane foam is a flexible polyurethane foam produced by the foregoing polyurethane reaction system, with the physical properties as described above.

The invention also provides use of the flexible polyurethane foam of the invention in household or automobile articles.

The invention also provides a polyurethane product comprising the flexible polyurethane foam of the invention.

Preferably, the polyurethane product is selected from the group consisting of household articles and automobile interiors, preferably sofas, mattresses, pillows, clothing paddings, back cushions, seat cushions and car seats.

### Components of the Polyurethane Foam Reaction System

A) Polyisocyanate

Any organic polyisocyanate can be used to produce the flexible polyurethane foam of the present invention, including aromatic, aliphatic and cycloaliphatic polyisocyanates and combinations thereof. The polyisocyanate can be represented by the general formula R(NCO)n, where R represents an aliphatic hydrocarbon group containing 2 to 18 carbon atoms, an aromatic hydrocarbon group containing 6 to 15 carbon atoms, or an araliphatic hydrocarbon group containing 8 to 15 carbon atoms, and n=2-4.

Useful polyisocyanates include, but are not limited to, vinyl diisocyanate, tetramethylene-1,4-diisocyanate, hexamethylene diisocyanate (HDI), dodecyl-1,2-diisocyanate, cyclobutane-1,3-diisocyanate, cyclohexane-1,3-diisocyanate, cyclohexane-1,4-diisocyanate, 1-isocyanato-3,3,5-trimethyl-5-isocyanatomethylcyclohexane, hexahydrotoluene-2,4-diisocyanate, hexahydrophenyl-1,3-diisocyanate, hexahydrophenyl-1,4-diisocyanate, perhydrogenated diphenylmethane-2,4-diisocyanate, perhydrogenated diphenylmethane-4,4-diisocyanate, phenylene-1,3-diisocyanate, phenylene-1,4-diisocyanate, stilbene-1,4-diisocyanate, 3,3-dimethyl-4,4-diphenyl diisocyanate, toluene-2,4-diisocyanate (TDI), toluene-2,6-diisocyanate (TDI), diphenylmethane-2,4′-diisocyanate (MDI), diphenylmethane-2,2′-diisocyanate (MDI), diphenylmethane-4,4′-diisocyanate (MDI), diphenylmethane diisocyanate and/or mixtures of diphenylmethane diisocyanate homologues with more rings, polyphenylmethane polyisocyanate (polymeric MDI), naphthylene-1,5-diisocyanate (NDI), isomers thereof, and any mixtures between the compounds and the isomers thereof.

Useful polyisocyanates further include isocyanates modified with carbodiimides, allophanates or isocyanates, preferably but not limited to, diphenylmethane diisocyanate, carbodiimide modified diphenylmethane diisocyanate, isomers thereof, mixtures between the compounds and isomers thereof.

When used in the present invention, polyisocyanates include isocyanate dimers, trimers, tetramers, or combinations thereof.

In a preferred embodiment of the present invention, the isocyanate includes a mixture of polymeric MDI, MDI and TDI. The NCO content of the mixture is 20 to 48 wt. %, preferably 25 to 45 wt. %, particularly preferably 28 to 40 wt. %. The NCO content is measured by GB/T 12009.4-2016.

Preferably, the mass ratio of the polymeric MDI, MDI and TDI in the mixture, in order, is polymeric MDI:MDI:TDI=1-55:1-45:5-80, more preferably=1-55:10-30:20-80.

The isocyanate component of the present invention comprises:
A1) toluene diisocyanate in a content of 15-80 pbw, preferably 30-65pbw, based on 100 pbw of the component B;
A2) at least one aliphatic isocyanate in a content of 1-13 pbw, preferably 1-12 pbw, more preferably 1-8 pbw, particularly preferably 4-7 pbw, based on 100 pbw of the component B.

Preferably, A2) the at least one aliphatic isocyanate is selected from the group consisting of isophorone diisocyanate, pentamethylene diisocyanate or a combination thereof.

Preferably, component A of the present invention exclusively consists of A1) and A2).

B) Polyol

The polyol of the present invention can be a polyether polyol, a polyester polyol, a polycarbonate polyol and/or mixtures thereof.

The polyol of the present invention is preferably one or more polyether polyol(s), wherein at least one polyether polyol is a polyether polyol with a multifunctional small molecule alcohol as the starter. The polyether polyol has a functionality of 2-8, preferably 3-6, and a hydroxyl value of 20-1200 mg KOH/g, preferably 20-800 mg KOH/g.

The polyether polyol can be produced by known processes. Generally, the polyether polyol is produced from ethylene oxide or propylene oxide with ethylene glycol, 1,2-propanediol, 1,3-propanediol, diethylene glycol, glycerin, trimethylolpropane, pentaerythritol, triethanolamine, toluene diamine, sorbitol, sucrose or any combinations thereof as the starter.

In addition, the polyether polyol can also be produced by reacting at least one alkylene oxide comprising an alkylene with 2 to 4 carbon atoms with a compound containing 2-8, preferably but not limited to 3 to 6, active hydrogen atoms or other reactive compounds in the presence of a catalyst.

Examples of the catalyst are alkali metal hydroxides such as sodium hydroxide, potassium hydroxide, or alkali metal alkoxides such as sodium methoxide, sodium ethoxide, potassium ethoxide, or potassium isopropoxide.

Useful alkylene oxides include, but are not limited to, tetrahydrofuran, ethylene oxide, 1,2-propylene oxide, 1,2-butylene oxide, 2,3-butylene oxide, styrene oxide and any mixtures thereof.

Useful compounds comprising active hydrogen atoms include polyhydroxy compounds, preferably, but are not limited to, water, ethylene glycol, 1,2-propanediol, 1,3-propanediol, diethylene glycol, trimethylolpropane, any mixtures thereof, more preferably, polyhydric, especially trihydric or higher alcohols, such as glycerol, trimethylolpropane, pentaerythritol, sorbitol and sucrose. Useful compounds comprising active hydrogen atoms further include, preferably, but are not limited to, organic dicarboxylic acids such as succinic acid, adipic acid, phthalic acid and terephthalic acid, or substituted aromatic or aliphatic diamines such as ethylenediamine, diethylenetriamine, triethylenetetramine, propylenediamine, butylenediamine, hexamethylenediamine or toluene diamine.

Other useful reactive compounds include ethanolamine, diethanolamine, methylethanolamine, ethylethanolamine, methyldiethanolamine, ethyldiethanolamine, triethanolamine, and ammonia.

The polyether polyol produced with an amine as the starter includes a compound obtained by reacting an amine as the starter with an alkylene oxide compound.

When used in the present invention, the term “alkylene oxide compound” generally means a compound with the following general formula (I):

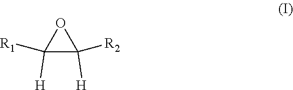

where R₁ and R₂ are independently selected from H, C₁-C₆ linear and branched alkyl groups, as well as phenyl and substituted phenyls.

Preferably, R₁ and R₂ are independently selected from H, methyl, ethyl, propyl and phenyl.

Those skilled in the art already know the methods for producing the “alkylene oxide compound”, for example, by the oxidation reaction of an olefin compound.

Examples of alkylene oxide compounds that can be used in the present invention include, but are not limited to: ethylene oxide, 1,2-propylene oxide, 1,2-butylene oxide, 2,3-butylene oxide, styrene oxide or mixtures thereof, particularly preferably mixtures of ethylene oxide and 1,2-propylene oxide.

When used in the present invention, the term “alkylene oxide compound” also includes oxacycloalkanes, examples of which include, but are not limited to: tetrahydrofuran and oxetane.

When used in the present invention, the term “amine” means a compound containing a primary amino group, a secondary amino group, a tertiary amino group, or a combination thereof. Examples of compounds that can be used as the amine of the present invention include, but are not limited to, triethanolamine, ethylenediamine, toluene diamine, diethylenetriamine, triethylenetetramine and derivatives thereof, preferably ethylenediamine and toluene diamine, particularly preferably toluene diamine.

The polyol component/component B of the present invention comprises:
B1) a polyether polyol having an ethylene oxide unit content of 0-30 wt. %, preferably 5-20 wt. % based on the total weight of B1, an average functionality of 2-4, and a hydroxyl value of 80-180 mg KOH/g (test method: GB/T 12008.3-2009), in a content of 30-100 pbw, preferably 80-100 pbw, based on 100 pbw of the component B.

Preferably, it further comprises:
B2) a polyether polyol having an ethylene oxide unit content of 0 wt. % based on the total weight of B2, an average functionality of 2-4, and a hydroxyl value of 200-340 mg KOH/g (test method: GB/T 12008.3-2009), in a content of 0-50 pbw, based on 100 pbw of the component B.

Preferably, it further comprises:
B3) a polyether polyol having an ethylene oxide unit content of 30-80 wt. % based on the total weight of B3, an average functionality of 2-4, and a hydroxyl value of 20-60 mg KOH/g (test method: GB/T 12008.3-2009), in a content of 0-70 pbw based on 100 pbw of the component B.

### Blowing Agent

The blowing agent of the present invention is preferably water in a content of 0.5-5 pbw, preferably 0.8-3.5 pbw, based on 100 pbw of the component B.

### Catalyst

The catalyst of the present invention is preferably an amine catalyst. The amine catalysts include, but are not limited to, one, two or more of triethylamine, tributylamine, dimethylethanolamine, bis(dimethylaminoethyl)ether, triethylenediamine, N-ethylmorpholine, N,N,N′,N′-tetramethyl-ethylenediamine, pentamethyldiethylenetriamine, dimethylaminopropylenediamine, N,N,N′,N′-tetramethyldipropylenetriamine and weak acid modified products of the above amine catalysts. The content of the catalyst of present invention is preferably 0.20-4.00 pbw based on 100 pbw of the component B.

### Surfactant

In some of the embodiments of the present invention, the polyurethane reaction system of the present invention further comprises a surfactant, which is preferably, but not limited to, an ethylene oxide derivative of a siloxane. The content of the surfactant is 0.1-3 pbw, preferably 0.25-2 pbw, based on 100 pbw of the component B.

Through experiments, it has been unexpectedly found that the polyurethane reaction system of the present invention including aliphatic diisocyanate and other components adapted thereto can reduce VOC, especially toluene diamine content in a simple, economical and effective manner, and provide a flexible polyurethane foam with excellent breathability and other physical properties.

### EXAMPLES

The test methods of the examples are described as follows:
indentation hardness means the force required to achieve a certain deformation using a standard sample under specified conditions and instrument test procedures, determined according to GB/T 10807-2006;
tensile strength means the maximum tensile stress that the sample is subjected to during the tensile process, determined according to GB/T 6344-2008;
tear strength means the force required to tear thin samples, determined according to GB/T 10808-2006;
air permeability means the ability of allowing air to pass through a foam body, with test method ASTM D3574-G and at test condition of a pressure difference of 125 Pa. The air permeability of the comparative Example 1 measured according to ASTM D3574--2005 was shown in Table 1; in Examples 1-3, no data can be measured at the pressure difference of 125 Pa using the aforementioned test method, indicating very good air permeability; when the test conditions were changed from the pressure difference 125 Pa to 120 Pa, 100 Pa and 80Pa, respectively, air permeability can be measured. The measured values were shown in Table 1 (the greater the pressure difference, the greater the measured value of air permeability).

Toluene diamine content test means qualitative and quantitative analyzation to 2,4-toluene diamine and 2,6-toluene diamine in a foam with the use of a high-performance liquid chromatograph (HPLC) equipped with a diode array detector (DAD), using a buffer solution and acetonitrile as mobile phases to flow through a reversed-phase C18 chromatographic column.

### Sources and Description of Raw Materials

The description of the specific examples and methods disclosed by the present invention is exemplary rather than limiting.

Isocyanate 1: toluene diisocyanate containing 80 wt. % of 2,4-isomer and 20 wt. % of 2,6-isomer, Desmodur T80, purchased from Covestro Polymers (China) Co., Ltd .;

Isocyanate 2: isophorone diisocyanate, Desmodur I, purchased from Covestro Polymer (China) Co., Ltd.;

Isocyanate 3: pentamethylene diisocyanate, commercially available;

Polyether polyol 1: average functionality 2-3, hydroxyl value 120 mg KOH/g, Softcel VE-1100, purchased from Covestro Polymers (China) Co., Ltd.;

Blowing agent 1: water;

Additive 1: Niax DP-1022, purchased from Momentive Inc.;

Surfactant 1: Niax L-618, Momentive Inc.;

Catalyst 1: Niax A-1, Momentive Inc.;

Catalyst 2: Niax A-33, Momentive Inc.;

Catalyst 3: Niax D-19, Momentive Inc.

### Preparation of the Flexible Polyurethane Foam of the Invention

The components as listed in Table 1 were stirred and mixed at normal temperature and pressure, foamed and shaped into flexible polyurethane foams.

TABLE 1
Examples 1-5 and Comparative Example 1

| | Com. | | | | | |
|---|---|---|---|---|---|---|
| | Example | Example | Example | Example | Example | Example |
| | 1 | 1 | 2 | 3 | 4 | 5 |
| Polyether polyol 1 | 100 | 100 | 100 | 100 | 100 | 100 |
| Water | 3.2 | 3.2 | 3.2 | 3.2 | 3.2 | 3.2 |
| Additive 1 | 1 | 1 | 1 | 1 | 1 | 1 |
| Surfactant 1 | 1.2 | 1.2 | 1.2 | 1.2 | 1.2 | 1.2 |
| Catalyst 1 | 0.06 | 0.06 | 0.06 | 0.06 | 0.06 | 0.06 |
| Catalyst 2 | 0.18 | 0.18 | 0.18 | 0.18 | 0.18 | 0.18 |
| Catalyst 3 | 0.1 | 0.1 | 0.1 | 0.1 | 0.1 | 0.1 |
| Isocyanate 2 | | 2 | 4 | 6 | 8 | |
| Isocyanate 3 | | | | | | 6 |
| Isocyanate 1 | 48.90 | 48.90 | 48.90 | 48.90 | 48.90 | 48.90 |
| 40% indentation | 33.24 | 44.79 | 53.10 | 52.82 | — | — |
| hardness, N | | | | | | |
| Tear strength, N/m | 219.10 | 309.23 | 360.52 | 347.67 | — | — |
| Tensile strength, | 70.52 | 79.88 | 99.30 | 91.72 | — | — |
| kPa | | | | | | |
| Air permeability, | 99 (@125 Pa) | 128 (@120 Pa) | 129 (@100 Pa) | 130 (@80 Pa) | | |
| L/min | | | | | | |
| 2,6-Toluene | 30.90 | 23.50 | 18.30 | 9.30 | ND | 1.10 |
| diamine, mg/kg | | | | | | |
| 2,4-Toluene | 39.50 | 28.60 | 17.30 | 7.90 | ND | ND |
| diamine, mg/kg | | | | | | |

ND in Table 1 means: not detected, or below the detection limit of the method.

As can be seen from the test results in Table 1, the polyurethane reaction system of the present invention, into which aliphatic diisocyanate, such as isophorone diisocyanate or pentamethylene diisocyanate, and other components adapted thereto were added, significantly reduced the content of toluene diamine in the flexible polyurethane foam system, so that flexible polyurethane foam articles with low or even no toluene diamine were obtained. Moreover, even at reduced test pressure differences, the air permeability values of Examples 1-3 were still much higher than that of the comparative example, indicating very good air permeability of the flexible polyurethane foam of the present invention.

Although the present invention has set forth the preferred examples as above, they are not intended to limit the present invention. Any skilled in the art are capable of making various changes and modifications without departing from the spirit and scope of the present invention. The scope of protection shall be determined by the scope of the claims of the patent application.

1. A method for producing flexible polyurethane foam, the method comprising producing the flexible polyurethane foam with a polyurethane reaction system comprising the following components:
Component A comprising:
A1) toluene diisocyanate in a content of 15-80 pbw based on 100 pbw of component B; and
A2) at least one aliphatic isocyanate in a content of 1-13 pbw based on 100 pbw of component B;
Component B, one or more polyether polyol(s), comprising:
B1) a polyether polyol having an ethylene oxide unit content of 0-30 wt. % based on the total weight of B1, an average functionality of 2-4, and a hydroxyl value of 80-180 mg KOH/g according to GB/T 12008.3-2009, in a content of 30-100 pbw based on 100 pbw of the component B;
Component C, at least one blowing agent; and
Component D, at least one amine catalyst.

2. The method according to claim 1, wherein A2) the at least one aliphatic isocyanate is selected isophorone diisocyanate, pentamethylene diisocyanate, or any combination thereof.

3. The method according to claim 1, wherein the reaction system does not include polyurea polyol.

4. The method according to claim 1, wherein the component A does not include hexamethylene diisocyanate.

5. A flexible polyurethane foam produced by the method for producing flexible polyurethane foam according to claim 1.

6. The flexible polyurethane foam according to claim 5, wherein the flexible polyurethane foam has a tear strength ≥220 N/m according to GB/T 10808-2006.

7. The flexible polyurethane foam according to claim 5, wherein the flexible polyurethane foam has a tensile strength >72 kPa according to GB/T 6344-2008.

8. The flexible polyurethane foam according to claim 5 wherein, the flexible polyurethane foam has a content of 2,4-toluene diamine ≤30 mg/kg.

9. A method for reducing the content of volatile organic compounds with an aliphatic isocyanate in flexible polyurethane foam.

10. The method according to claim 9, wherein the volatile organic compound is toluene diamine.

11. The method according to claim 9, wherein the flexible polyurethane foam is produced by a polyurethane reaction system comprising the following components:
Component A, including:
A1) toluene diisocyanate in a content of 15-80 pbw based on 100 pbw of component B;
A2) at least one aliphatic isocyanate in a content of 1-13 pbw based on 100 pbw of the component B;
the Component B, one or more polyether polyol(s), comprising:
B1) a polyether polyol having an ethylene oxide unit content of 0-30 wt. %, based on the total weight of B1, an average functionality of 2-4, and a hydroxyl value of 80-180 mg KOH/g according to GB/T 12008.3-2009, in a content of 30-100 pbw based on 100 pbw of the component B;
Component C, at least one blowing agent; and
Component D, at least one amine catalyst.

12. The method according to claim 9 wherein, the A2) is selected from the group consisting of isophorone diisocyanate, pentamethylene diisocyanate or any combination thereof.

13. A household article or an automobile article comprising the flexible polyurethane foam according to claim 5.

14. A polyurethane product comprising the flexible polyurethane foam according to claim 5.

15. The polyurethane product according to claim 14, wherein the polyurethane product is selected from the group consisting of household articles and automobile interiors.

16. The method according to claim 1, wherein component A1) comprises toluene diisocyanate in a content of 30-65 pbw based on 100 pbw of the component B.

17. The method according to claim 1, wherein component A2) comprises at least one aliphatic isocyanate in a content of 4-7 pbw, based on 100 pbw of the component B.

18. The method according to claim 1, wherein component B1) comprises a polyether polyol having an ethylene oxide unit content of 5-20 wt. % based on the total weight of B1.

19. The method according to claim 1, wherein component B1) comprises a polyether polyol 80-100 pbw based on 100 pbw of the component B.

20. The flexible polyurethane foam according to claim 6, wherein the flexible polyurethane foam has a tear strength ≥300 N/m according to GB/T 10808-2006.
